(19) United States
(12) Patent Application Publication
(10) Pub. No.: US 2026/0341128 A1
(43) Pub. Date: Oct. 29, 2026

(54) HAND-HELD POWER TOOL WITH HAPTIC FEEDBACK

(71) Applicant: Robert Bosch GmbH, Stuttgart (DE)

(72) Inventors: Jeremy Rubens, Palatine, IL (US); James Knea, Arlington Heights, IL (US)

(21) Appl. No.: 19/187,194

(22) Filed: Apr. 23, 2025

(51) Int. Cl. G08B 6/00; B06B 1/16; B25F 5/00

(52) U.S. Cl. CPC G08B 6/00; B06B 1/16; B25F 5/00

(57) ABSTRACT

A hand-held power tool includes a tool housing, an electric motor disposed in the tool housing, a power supply that provides power to the electric motor and a controller configured to control operation of the motor. Motor operation may be controlled to generate a desired auditory and/or haptic user experience corresponding to a desired perception of the tool. Alternatively, motor operation may be controlled to generate a desired auditory and/or haptic feedback to a user of the tool for example to signal an operating state of the tool.

### BACKGROUND

During operation of some hand-held power tools, the tool may become overloaded due to the operating style of the user, use of inappropriate cutting accessories for the material of a workpiece or other circumstances. Some hand-held power tools may shut off without warning if the overload conditions warrant it. This is referred to as “nuisance tripping.” In some cases, following nuisance tripping, the tool will not operate again until a short period of time has passed during which the tool may cool down and/or reset. Users may find the suddenness of the tool shut off to be disconcerting and/or the delay in restart to be inconvenient.

It is desirable to provide the user with a warning of an overload condition prior to the occurrence of nuisance tripping in order to avoid the discomfort of sudden tool shut down and/or the delay in tool operation.

### SUMMARY

Users may adapt the way they use and handle hand-held power tools based on how the tool feels during operation. For example, the sound (i.e., pitch, volume and duration) and feel of the tool in hand can communicate to the user how the tool is performing including whether the tool is struggling. The sound and feel of the tool in hand may also provide a perception of the general quality of the tool. The perception of the tool and the feedback given to the user by the tool may also change the way that the user operates a tool. For example, if the tool sounds like it is struggling during operation, the user may relieve or stop loading the tool.

In some aspects, a hand-held power tool includes a motor and controller that controls operation of the motor in a way that influences the user experience of the tool.

In some embodiments, the controller may control the motor in such a way as to generate a desired perception of the tool. In particular, the controller may control the motor to generate a desired auditory and/or haptic user experience while operating the tool and/or so that the user perceives the tool in a desired way. For example, in some cases, the controller may control the motor in such a way that that user perceives that the motor is powerful due to generation by the motor of a “rumble” or “growl”. In other cases, the controller may control the motor in such a way that the user perceives the sound generated by the motor to be soothing. This may be useful, for example, for grinding-type rotary power tools used to groom pet nails and claws.

In some embodiments, the controller controls the motor in such a way as to generate haptic feedback to a user of the tool. For example, during tool overload, the controller controls the motor in such way that the user perceives a vibrational change from normal operation of the motor. In some cases, the controller may control the motor in a repeated pattern that includes motor speed reduction followed by return to normal speed at a frequency that can be perceived by the user. In other cases, the controller may control the motor in a random pattern of motor speed changes at a frequency that can be perceived by the user. When such speed changes occur during tool operation, the user is able to receive the feedback generated by the tool and take appropriate corrective steps. The motor speed changes may provide the user with haptic feedback, auditory feedback or both haptic and auditory feedback that differ from the perceived feedback obtained during normal tool use to indicate a particular operating condition of the tool.

The frequency range that can be perceived by the human hand through vibration, referred to herein as a “haptic” vibration, is in a range of about 10 Hz to about 1000 Hz. The frequency range around and including 125 Hz, corresponding to the natural resonant frequency of a human hand, is considered to be the most sensitive range of frequency for haptic perception by the hand. Thus, even low amplitude vibrations may be felt at 125 Hz. While frequencies lower than 10 Hz may be perceived by the hand, the vibration may be perceived as a pressure rather than a distinct vibration. Above 1000 Hz, it becomes difficult to distinguish vibrations. “Foldback” is a protection mechanism used to prevent damage to the motor and controller in the event of an overload condition. In foldback, the controller continuously monitors the current flowing through the motor coils. If the current exceeds a predefined threshold (indicating an overload condition), the controller activates the foldback protection. Instead of allowing the current to continue rising, which could damage the motor or controller, the foldback mechanism reduces the output current to a safe level. This may be achieved, for example, by adjusting the Pulse Width Modulation (PWM) signal or by reducing the voltage supplied to the motor. The foldback mechanism allows the motor to continue operating, albeit at a reduced torque. This is important for applications where maintaining some level of control is necessary, even under load. In the hand-held power tool described herein, the controller may use a foldback algorithm to protect a power tool from overloading and also to intentionally signal to the user that the tool is being overloaded. Once the overload condition is resolved (e.g., the load is removed or reduced), the controller can gradually restore the current to its normal operating level, allowing the motor to return to full performance.

This can be compared to some conventional power tools in which foldback algorithms are used to drop the voltage of the tool during potential high loading conditions to protect the tool, for example generating nuisance tripping. Any corresponding audible indication to the user of the state of operation during the voltage drop is typically unintended and may be displeasing.

In some aspects, a hand-held power tool includes a tool housing and an electric motor disposed in the tool housing. The electric motor has an output shaft that is configured to be connected to an accessory of the tool. The hand-held power tool includes a power supply that provides power to the electric motor and a controller disposed in the tool housing. The controller is powered by the power supply and is configured to control a speed of the motor. During use, the power tool has characteristic vibrations that result in at least one of a characteristic haptic effect and a characteristic auditory effect that are perceivable by a user of the tool. The controller is configured to control the motor in such a way that the power tool is capable of producing alternative vibrations that result in at least one of an alternative haptic effect and an alternative auditory effect. The alternative haptic effect is different than the characteristic haptic effect, and the alternative auditory effect is different than the characteristic auditory effect.

In some embodiments, the controller is configured to receive a signal corresponding to a detected load on the electric motor during motor operation. When the controller determines that the detected load on the electric motor exceeds a predetermined load, the controller is configured to control the motor in such a way that the motor provides the alternative haptic effect indicating an overload state of the motor to a user of the power tool.

In some embodiments, the alternative haptic effect comprises changes in motor speed of the type selected from the following group: rhythmic, musical, discontinuous, non-linearly varying, sinusoidally varying.

In some embodiments, the alternative haptic effect comprises cycling the motor speed in a repeated pattern in which the speed of the motor is reduced from a set speed to a predetermined speed and then increased from the predetermined speed to the set speed.

In some embodiments, the alternative haptic effect comprises cycling the motor speed in a repeated pattern in which the speed of the motor is reduced from a set speed to a predetermined speed and then increased from the predetermined speed to the set speed in accordance with a predefined rhythm.

In some embodiments, the controller is configured to control the motor in such a way that the motor provides both the alternative haptic effect and the alternative auditory effect to the user.

In some embodiments, the controller is configured to receive a signal corresponding to a detected charge condition of the power supply during motor operation. When the controller determines that the detected charge condition is less than a predetermined charge condition, the controller is configured to control the motor in such a way that the motor provides the alternative haptic effect indicating a low charge state of the power supply to a user of the power tool.

In some embodiments, the controller is configured to control the motor such that both the alternative haptic effect and the alternative audible effect are provided to the user.

In some embodiments, the controller is configured to receive a signal corresponding to a detected angular orientation of the tool housing in space during tool operation. When the controller determines that the detected angular orientation of the tool housing is outside a predetermined range of acceptable angular orientations of the tool housing, the controller is configured to control the motor in such a way that the motor provides the alternative haptic effect indicating a suboptimal tool housing orientation to a user of the power tool.

In some embodiments, the controller is configured to control the motor such that both the alternative haptic effect and the alternative audible effect are provided to the user.

In some embodiments, the controller is configured to detect a current provided to the electric motor during motor operation. When the detected current corresponds to a first current that results in vibrations known to be perceived negatively by a user, the controller is configured to control the motor in such a way that the motor provides the alternative haptic effect.

In some embodiments, the detected current corresponds to a first current that results in vibrations known to be perceived negatively by a user, the controller is configured to control the motor in such a way that the motor provides vibrations known to be perceived positively by a user.

### BRIEF DESCRIPTION OF THE FIGURES

FIG. 1 is a perspective exploded view of a hand-held rotary power tool and an accessory.

FIG. 2 is a side cross-sectional view of the tool.

FIG. 3 is a schematic view of the electrical circuit of the tool.

FIG. 4 is a flow chart of the operation of the tool.

FIG. 5 is a schematic illustration of a duty cycle of the tool output.

FIG. 6 is a schematic illustration of a duty cycle of a conventional tool.

FIG. 7 is a schematic diagram illustrating how a first frequency switching profile A (uppermost graph of V versus time) and a second switching profile B (middle graph of V versus time) are combined (lowermost graph of V versus time), e.g., A+B, shown in a broken line.

FIG. 8 is a flow chart of the operation of an alternative embodiment of the tool.

FIG. 9 is a chart showing common perception descriptors and corresponding frequency ranges.

FIG. 10 is a schematic view of an alternative electrical circuit of the tool.

### DETAILED DESCRIPTION

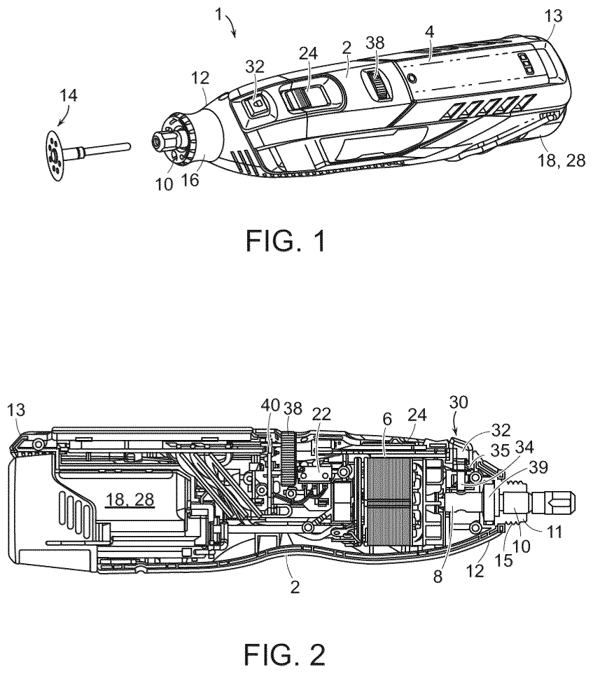

Referring to FIGS. 1-3, the hand-held rotary power tool 1 includes a tool housing 2. The tool housing 2 has a generally cylindrical shape that is ergonomically contoured to be grasped in the hand of a user, whereby a central portion 4 of the tool housing 2 serves as a handle or grip of the rotary power tool 1. The rotary power tool 1 includes an electric motor 6 disposed in the tool housing 2. The motor 6 is controlled by a controller 36 via an electrical circuit 20 that includes an on/off electrical switch 22 and a power supply 18. An output shaft 8 of the motor 6 extends in parallel to an elongation direction of the tool housing 2 and is connected in a gearless fashion to a tool spindle 10. The tool spindle 10 protrudes outward from a first end 12 of the tool housing 2 and is configured to provide a mechanical connection to various workpiece modifying accessories 14 for the purpose of processing a workpiece. The accessories 14 may include, but are not limited to, engraving cutters, milling cutters, grinding disks, grindstones, polishing tips, polishing disks, polishing brushes, cutting disks, saw blades and bits. An exemplary accessory 14 in the form of a cutting disc is shown in FIG. 1.

The motor 6 is powered by the power supply 18 that is detachably connected to a second end 13 of the tool housing 2. The switch 22 is disposed in the electrical circuit 20 between the controller 36 and the power supply 18. The electrical switch 22 is entirely disposed within the tool housing 2 and is actuated by an operator of the rotary power tool 1 via a switch actuator 24. The switch actuator 24 is protrudes through an opening in the tool housing 2 so as to be accessible to an operator of the rotary power tool 1.

In the illustrated embodiment, the power supply 18 includes a rechargeable battery pack 28 that is detachably connected to the tool housing second end 13. In other embodiments, the power supply 18 may consist of primary batteries that are housed within the tool housing 2. In still other embodiments, the power supply 18 may be remote from the tool housing 2 and connected to the tool housing 2 via a cord (not shown) that encloses an electrically conductive wire.

The motor 6 may be a brushed or brushless DC motor. When the electrical switch 22 is in the “on” position, the motor 6 drives the tool spindle 10 at a rotational speed higher than 10 000 min−1. In some embodiments, the rotational speed of the motor 6 can be adjusted by an operator between 5 000 min−1 and 40 000 min−1 via a rotary speed control knob 38.

In some embodiments, the rotary power tool 1 includes an output shaft lock mechanism 30 having a depressible control button 32 that caps a locking shaft 34. The locking shaft 34, when actuated by the control button 32, is configured to engage an opening in the output shaft 8 to prevent rotation of the output shaft 8 while an accessory 14 is being attached thereto. The output shaft lock mechanism 30 also includes a spring 35 that biases the locking shaft 34 and control button 32 toward a disengaged configuration.

The tool housing 2 encloses the motor 6, the output shaft lock mechanism 30, the electrical switch 22, the controller 36 and other ancillary components and structures. The tool housing 2 supports the switch actuator 24, the speed control knob 38, output shaft support bearings 39 and the battery pack 18.

The tool housing first end 12 includes an annular protrusion 11 that is centered on the rotational axis of the spindle 10. The protrusion 11 encircles the spindle 10 with sufficient clearance to permit rotation of the spindle 10 therein and has an outer thread 15 that permits attachments 16 to be connected to the rotary power tool 1. The spindle 10 extends through the protrusion 11 and a terminal end of the spindle 10 resides outside the protrusion 11. In FIG. 1, an attachment 16 referred to as a nose piece is threaded onto the protrusion outer thread 15. The nose piece outer surface defines an annular concavity that provides a finger grip that is useful for some applications of the power tool 1.

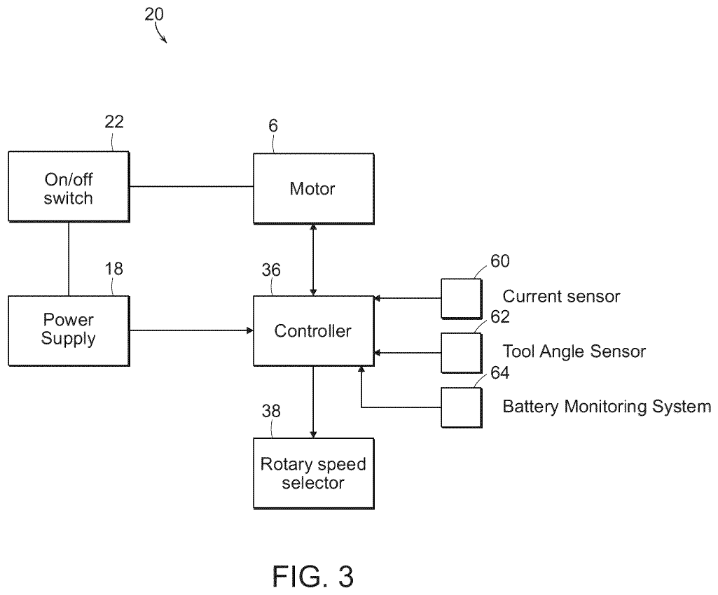

Referring to FIGS. 2 and 3, the controller 36 is part of a printed circuit board assembly (PCBA) 40 that includes other ancillary electronic devices (not shown) supported on a printed circuit board (PCB) 42. The electronics supported on the PCBA 40, including the controller 36, are powered by the power supply 18. The controller 36 may be communicatively coupled with various operational components of rotary power tool 1, including, but not limited to, the electrical switch 22, the rotary speed control knob 38, a battery management system (BMS), sensors or other input devices, etc.

As used herein, the term “communicatively coupled” may refer to a direct wired connection via for example conductive signal lines, shared communication busses, or alternatively may refer to a wireless connection. As used herein, references to wireless connectivity or communication indicates that the device may be configured to communicate wirelessly via one or more of an RF (radio frequency) specification, cellular phone channels (analog or digital), cellular data channels, a Bluetooth specification, a Wi-Fi specification, a satellite transceiver specification, infrared transmission, a Zigbee specification, Local Area Network (LAN), Wireless Local Area Network (WLAN), or any other alternative configuration, protocol, or standard known to one of ordinary skill in the art.

In some embodiments, controller 36 includes one or more memory devices and one or more processors. The processors may be any combination of general or special purpose processors, CPUs, or the like that can execute programming instructions or control code associated with operation of the rotary power tool 1. The memory devices (i.e., memory) may represent random access memory such as DRAM or read only memory such as ROM or FLASH. In some embodiments, the processor executes programming instructions stored in memory. The memory may be a separate component from the processor or may be included onboard within the processor. Alternatively, the controller 36 may be constructed without using a processor, for example, using a combination of discrete analog or digital logic circuitry (such as switches, amplifiers, integrators, comparators, flip-flops, AND gates, and the like) to perform control functionality instead of relying upon software.

In some embodiments, the controller 36 may include a network interface such that the controller 36 can connect to and communicate over one or more networks (not shown). The controller 36 may also include one or more transmitting, receiving, or transceiving components for transmitting and/or receiving communications with other devices communicatively coupled with the rotary power tool 1. Additionally, or alternatively, the transmitting, receiving, or transceiving components can be located off board controller 36. Generally, the PCBA 40 including the controller 36 may be positioned in any suitable location throughout tool housing 2.

The various functions performed by the controller 36 may be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Thus, controller 36 can receive information from several components and devices and selectively activate and operate various operational components. The controller 36, for example, may control a voltage supplied to the motor 6. The controller 36 regulates the speed and torque of the motor 6 by adjusting the voltage and/or current supplied to the motor 6. The controller 36 varies these parameters based on input signals, such as from a potentiometer (not shown), an encoder (not shown) or sensors such as a current sensor 60, tool angle sensor 62 and/or a battery management system 64. The battery management system 64 may be configured to monitor battery temperature, state of charge (SOC) and/or other relevant metrics. By controlling the power supplied to the motor 6, the controller 36 effectively governs its speed and torque output. Additionally, feedback mechanisms like the potentiometer, the encoder and the sensors 60, 62, 64 can provide information to the controller 36, allowing it to adjust its output to maintain desired speed and torque levels.

During use, the power tool 1 has characteristic vibrations that result in one or both of a characteristic haptic effect and a characteristic auditory effect that are perceivable by a user of the tool. The characteristic vibrations occur, at least in part, due to motor operation, mechanical movements of internal tool components (gearing, bearings, etc.), mechanical movement of tool accessories (bits, blades, etc.) while moving freely or when under load against a work piece, resonation of motor and internal component vibration through the tool housing which may amplify the effect of the vibration, and friction between moving parts of the tool. The characteristic auditory effect corresponds to the auditory component of the characteristic vibrations that occur during tool use, while the characteristic haptic effect corresponds to the haptic component of the characteristic vibrations that occur during tool use.

The hand-held power tool 1 includes a motor control system 100 in which the controller 36 controls operation of the motor 6 in a way that intentionally influences the user experience of the tool in a predetermined way.

In some embodiments, the controller 36 controls the motor 6 so as to provide haptic feedback to a user of the tool 1. In particular, the sound, pitch and feel of the tool 1 in use is controlled to communicate to the user an operating condition of the tool 1. Operating conditions that warrant communication to the user may include, but are not limited to, a tool overload condition, a low power supply state of charge condition and/or a tool spatial orientation condition.

For example, when the power tool 1 is being operated, the during tool overload, the controller 36 controls the motor 6 in such way that alternative vibrations are generated whereby the user perceives a vibrational change from the characteristic vibrations of the tool 1. The vibrational change may be perceived haptically via an alternative haptic effect, auditorily via an alternative auditory effect or both haptically and auditorily. The alternative auditory effect corresponds to the auditory component of the alternative vibrations that occur while the alternative vibrations are being generated, while the alternative haptic effect corresponds to the haptic component of the alternative vibrations that occur while the alternative vibrations are being generated.

In some cases, the alternative vibrations include a repeated pattern achieved by motor speed reduction followed by return to normal speed at a frequency that can be perceived by the user. In other cases, the alternative vibrations include a random pattern of motor speed changes at a frequency that can be perceived by the user. In still other cases, the alternative vibrations occur in a pattern at a frequency that can be perceived by the user and may be perceived as one of discontinuous, non-linearly varying, sinusoidally varying, rhythmic and/or musical. In particular, the motor speed changes may provide the user with an alternative haptic effect, an alternative auditory effect or both alternative haptic and alternative auditory effects that differ from the characteristic vibrations. Thus, the tool 1 provides a vibrational signal to the user to indicate a particular operating condition of the tool and the user can then take appropriate steps as needed.

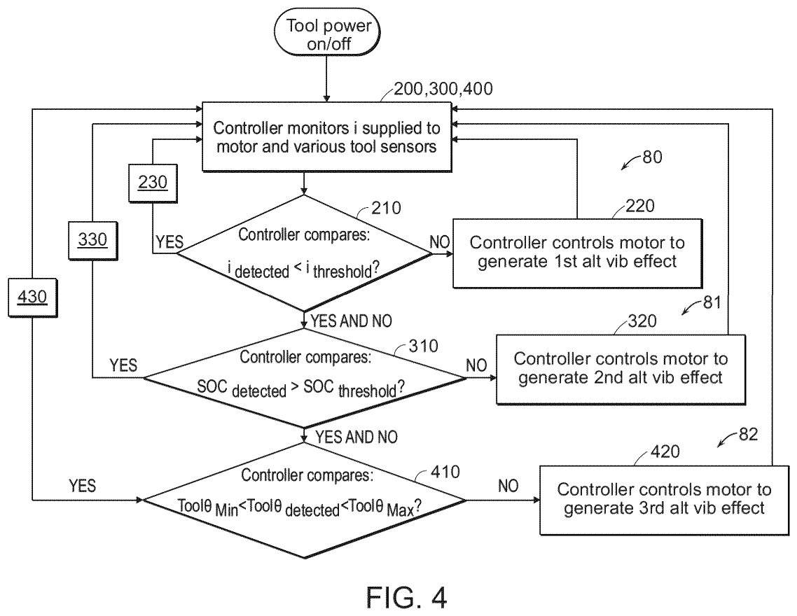

Referring to FIGS. 4-6, a first type of foldback control, referred to herein as an “informing” foldback mechanism 80, is implemented by the controller 36 to provide the alternative vibrations for the purpose of communicating to the user a particular operating condition of the tool 1. The informing foldback mechanism 80 includes the following process steps (FIG. 4). For example, upon switching of the on/off switch of the tool 1 to an “on” position, the controller 36 monitors the current flowing to the motor 6 (step 200). Monitoring may be implemented continuously or periodically and may be achieved using a current sensor 60, a shunt resistor 66 or other known technique.

The current sensor 60 detects and measures the amount of current flowing through a conductor, i. The current sensor 60 may be a Hall Effect current sensor, a Rogowski coil sensor or other known current sensor.

In some embodiments, the shunt resistor 66 is used rather than the current sensor 60. The shunt resistor 66 indirectly detects and measures the amount of current flowing through the motor 6. In these embodiments, the shunt resistor 66 may be a precision resistor placed in series with the motor 6 to measure current by measuring the voltage drop across motor 6. The value of the shunt resistor 66 is typically very low (in the milliohm range) to minimize power loss and heat generation. Since, according to Ohm's Law (V=I×R), voltage drop across the shunt resistor 66 is proportional to the current flowing through the motor 6, the current flowing through the motor 6 can be calculated.

The controller 36 compares the detected current to a maximum current threshold (step 210). The maximum current threshold is established based on the motor's specifications. For example, the maximum current threshold may be set as the maximum allowable current that the motor 6 can accommodate without overheating.

When the detected current approaches a maximum current threshold, the controller 36 controls the motor 6 to generate alternative vibrations that indicate an overload condition of the tool to the user (step 220).

Generation of the alternative vibrations used in the informing foldback mechanism 80 may be achieved via a current limiting approach. For example, in the first foldback mechanism, the controller may implement a current limiting strategy where the Pulse Width Modulation (PWM) duty cycle is adjusted to limit the current. By appropriately adjusting the duty cycle, the average voltage and current supplied to the motor are modulated to achieve the desired vibrational pattern and effect, e.g. a first alternative vibrational effect. As a result, the controller 36 controls the motor speed to provide predetermined alternative haptic and/or auditory effects associated with tool overloading.

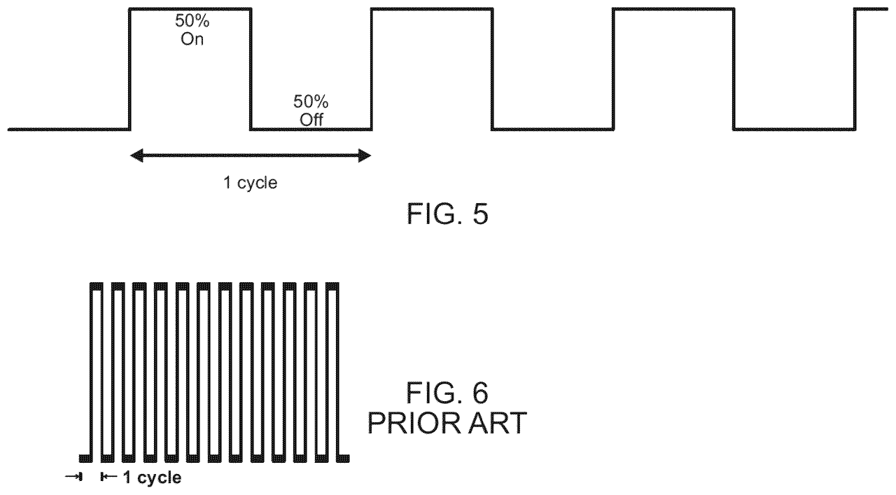

To intentionally signal to the user that the tool is being overloaded, the controller may, for example, employ a foldback algorithm including a high frequency pulse modulation that generates a switching frequency in the haptic range (e.g., a frequency of 1 to 300 Hz) using a 50 percent duty cycle (FIG. 5). This can be compared to a conventional foldback frequency, which may have the same duty cycle while being in a relatively higher frequency range (e.g., greater than 5000 Hz)(FIG. 6). The conventional foldback generates a switching frequency outside of the haptic range and the user only senses the drop in speed of the tool.

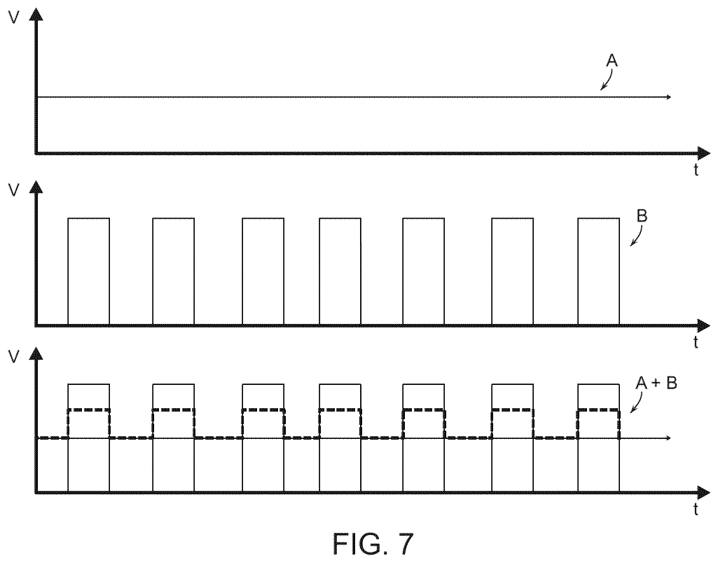

Switching frequencies and duty cycles are may be used by the controller 36 to induce a specific perceivable vibration through the motor of the tool to let the user know that the tool is struggling. For example, the controller 36 may switch between multiple foldback settings in order to achieve low frequency vibrations as shown in FIG. 7. In FIG. 7, a switching frequency having profile A is combined with a switching frequency having profile B to achieve an averaged switching frequency. In some cases, a “chord-like” effect may be achieved by rapidly changing the frequencies over time to achieve a specific sound and induce multiple frequencies.

When the tool is operated using the informing foldback mechanism, the user perceives the haptic information as a warning of overload conditions in the tool, avoiding nuisance tripping of the tool. In another example, the controller may employ a foldback algorithm including a high frequency pulse modulation that generates one or more switching frequencies to provide indications in both in the haptic range and in the audible range (e.g., a frequency of 20 Hz to 20,000 Hz). The haptic and/or audible range frequency may be tuned to provide a specific and/or characteristic tone or tones, rhythm(s) or chord(s), loudness, pitch and/or timbre selected to avoid abrasiveness and, in some examples, achieve pleasantness. In some cases, the haptic and/or audible sound produced may be musical (e.g., sounds that are organized or melodic and perceived as being pleasing or harmonious).

In some embodiments, the first alternative vibrational effect includes changes in motor speed of the type selected from the following group: rhythmic, musical, discontinuous, non-linearly varying, sinusoidally varying. For example, the alternative haptic effect may include cycling the motor speed in a repeated pattern in which the speed of the motor is reduced from a set speed to a predetermined speed and then increased from the predetermined speed to the set speed in accordance with a predefined rhythm. The rhythm may have a musical quality or reflect a known melody or a unique melody. In some cases, such rhythms may be perceived as soothing. In other cases, the rhythm may be non-melodious and/or intentionally jarring or discordant.

The user, upon perceiving the emitted motor vibrations, adjusts the load on the tool 1, preventing the motor from drawing excessive current.

The controller 36 continues to monitor the current flowing to the motor 6 and continues to compare the detected current to a maximum current threshold. When the detected current is below the maximum current threshold, the controller 36 controls the motor 6 to stop generating alternative vibrations that indicate an overload condition of the tool to the user (step 230). The controller 36 may gradually restore the voltage and current to normal operating levels. This recovery process may be smoothly implemented to avoid sudden changes that could destabilize the motor operation.

By preventing the motor 6 from overheating, the possibility of insulation failure and permanent motor damage can be prevented. In addition, protecting the motor from excessive current increases the overall reliability and lifespan of the motor 6 and the controller 36.

By employing the informing foldback mechanism 80, a tool overload operating condition may be addressed without nuisance tripping.

Thus, the informing foldback mechanism 80 can be positively compared to a conventional foldback mechanism in which the controller reduces the voltage supplied to the motor, which in turn reduces the current flowing through it.

In some cases, the controller 36 may control the motor 6 to provide both the informing foldback mechanism 80 and a conventional foldback mechanism. This can occur simultaneously or sequentially. In some cases, the conventional foldback mechanism may be employed if the user does not respond appropriately to the informing foldback mechanism 80 within a predetermined time period.

In some embodiments, the controller 36 is capable of providing, and selecting from, multiple informing foldback mechanisms 80. For example, the controller 36 may be able to provide the informing foldback mechanism 80 discussed above (e.g., the “overload informing foldback mechanism 80”) upon detection of an overload operating condition. In addition, the controller 36 may be able to provide a power status informing foldback mechanism 81 that is different from the overload informing foldback mechanism 80 and indicates a low state of charge of the battery. Alternatively, the power status informing foldback mechanism 81 could monitor the battery temperature (not illustrated here) rather than the state of charge of the battery 18. The power status informing foldback mechanism 81 is similar to the overload foldback mechanism 80 described above, as will now be described.

In the power status informing foldback mechanism 81, the controller 36 is configured to receive a signal corresponding to a detected charge condition of the power supply during motor operation (step 300). The signal may be generated by the battery management system 64.

The controller 36 compares the detected state of charge to a minimum state of charge threshold (step 310). The minimum state of charge threshold is established based on the motor's specifications. For example, the minimum state of charge threshold may be set as the battery charge state sufficient to provide the minimum amount of current required for the motor 6 to operate under normal load.

When the controller 36 determines that the detected state of charge is less than a predetermined minimum state of charge threshold, the controller 36 is configured to control the motor 6 in such a way that the motor 6 generates a second alternative vibrational effect that is different from the first vibrational effect provided in step 120 (step 320). The second alternative vibrational effect is configured to indicate a low charge state of the power supply to a user of the power tool. The second alternative vibrational effect may include haptic, auditory or both haptic and auditory characteristics.

The controller 36 continues to monitor the detected state of charge and continues to compare the detected state of charge to the minimum state of charge threshold. When the detected state of charge is above the minimum state of charge threshold, the controller 36 controls the motor 6 to stop generating vibrations that indicate a low state of charge of the power supply 18 to the user (step 330).

In addition to the overload and power status informing foldback mechanisms 80, 81, the controller 36 may be capable of providing a tool attitude informing foldback mechanism 82 that is different from the overload and power status informing foldback mechanisms 80, 81 and indicates an angle of the tool 1 relative to the workpiece based on input from a tool angle sensor.

In the tool attitude informing foldback mechanism 82, the controller 36 is configured to receive a signal corresponding to a detected angle of the tool housing 2 in space during tool operation (step 400). The signal may be generated by a tool angle sensor 62 such as a gyroscope.

The controller 36 compares the detected tool angle to a predetermine range of acceptable angular orientations of the tool housing (e.g., tool θₘᵢₙ<tool θ_{detected} tool θₘₐₓ)(step 410). The predetermined range of acceptable angular orientations is established based on tool operating specifications. For example, the predetermined range of acceptable angular orientations may be set to the range of orientations of the tool housing with respect to a workpiece corresponding to optimal effectiveness of the tool 1 during use.

When the detected angular orientation of the tool housing 2 is outside the predetermine range of acceptable angular orientations of the tool housing 2, the controller 36 is configured to control the motor 6 in such a way that the motor 6 generates a third alternative vibrational effect indicating to the user a suboptimal tool housing orientation (step 420). The third alternative vibrational effect is different from the first alternative vibrational effect provided in step 120 and the second alternative vibrational effect provided in step 220. The third alternative vibrational effect may include haptic, auditory or both haptic and auditory characteristics.

The controller 36 continues to monitor the tool housing angular orientation and continues to compare the detected angular orientation of the tool housing 2 the predetermine range of acceptable angular orientations of the tool housing 2. When the detected tool housing angular orientation is within the predetermine range of acceptable angular orientations of the tool housing 2, the controller 36 controls the motor 6 to stop generating vibrations that indicate to the user an inefficient tool housing orientation (step 430).

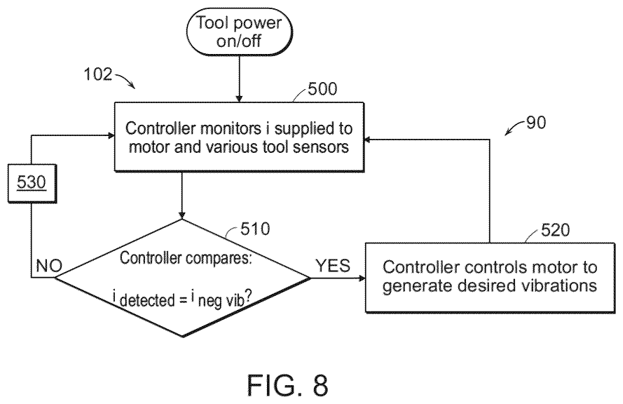

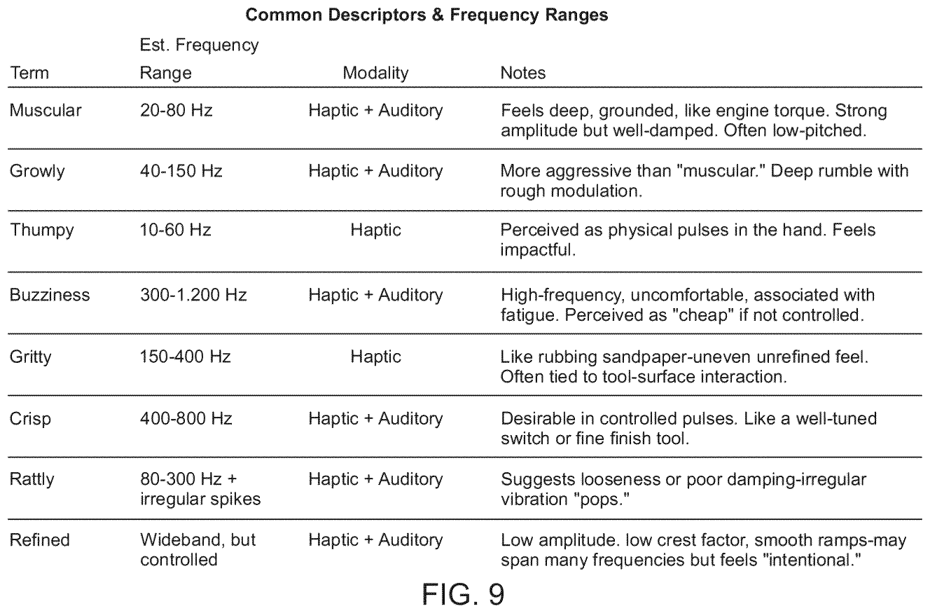

Referring to FIGS. 8 and 9, in an alternative embodiment motor control system 102, a second type of foldback control, referred to herein as an “experiencing” foldback mechanism 90, is implemented by the controller 36 to provide the alternative vibrations for the purpose of communicating to the user a general quality perception of the tool 1 (FIG. 8). More specifically, the controller 36 may control the motor 6 to generate a desired auditory and/or haptic user tool operating experience so that the user perceives the tool 1 in a desired way.

For example, in some cases, the controller 36 may control the motor 6 in such a way that the user perceives that the motor 6 is powerful and/or that the tool 1 is forceful due to generation by the motor 6 of vibration or set of haptically-and/or auditorily-perceivable vibrations known to be perceived as powerful or forceful.

In other cases, the controller 36 may control the motor 6 in such a way that the user perceives the haptic and/or auditory vibrations generated by the motor 6 to be soothing or pleasing. In some embodiments, the vibrations may reflect changes in motor speed of the type selected from the following group: rhythmic, musical, discontinuous, non-linearly varying, sinusoidally varying.

In still other cases, the controller 36 may control the motor 6 so as to prevent unpleasant or irritating haptic and/or auditory vibrations from being emitted from the tool 1 by employing vibration cancellation techniques.

Descriptive terms like “pleasing, displeasing, pleasant, unpleasant, soothing, irritating, annoying, soft, smooth, harsh, powerful, forceful, muscular, weak, feeble, buzzy, gritty, refined,” etcetera, when applied to vibrations emitted from a hand-held power tool, are commonly understood and many users of a hand-held power tool would have common perceptions in accordance with these terms. Examples of some common descriptive terms along with their corresponding frequency range and vibration modality are provided in FIG. 9.

The experiencing foldback mechanism 90 may be implemented to provide the haptic or haptic-plus-auditory tool vibrations for the purpose of communicating to the user a desired perception of the tool 1 during tool operation. In the experiencing foldback mechanism 90, the controller 36 monitors the current flowing to the motor 6 (step 500) (FIG. 8). Current monitoring may be implemented continuously or periodically and may be achieved using the current sensor 60, the shunt resistor 66 or other known technique.

In some embodiments, based on the detected current flowing to the motor 6, the controller 36 identifies operating conditions in which the motor 6 emits vibrations which are likely to be perceived negatively, such as unpleasant or fatiguing vibrations (step 510). The identification of such operating conditions may be achieved by the controller 36, for example, using an appropriate look-up table stored in memory or other known technique.

If the controller 56 determines that the motor 6 is likely to be emitting vibrations that may be perceived negatively, the controller 36 activates the experiencing foldback mechanism 90 (step 520). In the experiencing foldback mechanism 90, the controller 36 controls the motor 6 to generate a desired auditory and/or haptic vibrations to supplant and/or counteract the negatively-perceived vibrations. In other words, the controller 36 controls the motor 6 to obscure, neutralize or take the place of the negatively-perceived vibrations.

Generation of the desired auditory and/or haptic vibrations used in the experiencing foldback mechanism 90 may be achieved via a current limiting approach. For example, in the experiencing foldback mechanism 90, the controller may implement a current limiting strategy where the PWM duty cycle is adjusted to limit the current. By appropriately adjusting the duty cycle, the average voltage and current supplied to the motor are modulated to achieve the desired vibrational pattern and effect. As a result, the controller 36 controls the motor speed to provide the predetermined haptic or haptic-plus-auditory tool vibrations associated with the desired perception. The user, upon perceiving the emitted motor vibrations, has a positive user experience.

In some embodiments, counteraction can be achieved by controlling the motor in such a way that the motor 6 produces vibrations that are positively perceived. For example, the controller 36 may control the motor 6 to produce vibrations that are perceived as forceful or powerful. In another example, the controller 36 may control the motor 6 to produce vibrations that are perceived as soothing or pleasing.

In some embodiments, counteraction can be achieved by employing a vibration-cancellation scheme. For example, the controller 36 may control the motor 6 to produce vibrations that are opposite and equal to the negatively perceived vibrations.

In some cases, the controller 36 may control the motor 6 to provide both the informing foldback mechanism 80, 81 and/or 82 and the experiencing foldback mechanism 90. This can occur simultaneously or sequentially.

In some cases, the tool 1, in normal operation, may have a core frequency that happens to be an unpleasant sound to the human ear (i.e., a core frequency of 500 Hz). To address the unpleasant vibration, the controller 36 intentionally controls the motor speed to induce sounds and vibrations that compliment the core sound of the tool to make it more pleasant sounding. In this example, rapid switching between multiple frequency settings may be used to induce multiple frequencies through the motor. This creates chord-like sounds that compliment the core frequency of the tool.

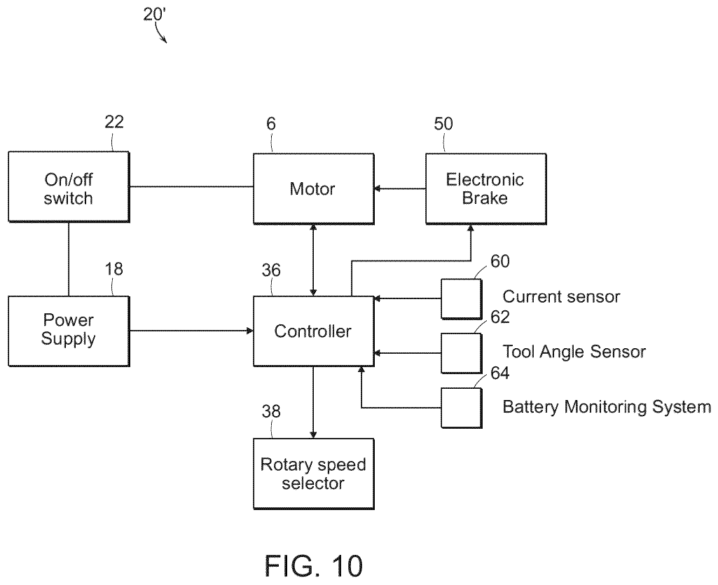

Referring to FIG. 10, in some embodiments, the power tool 1 may include an electronic brake 50 to moderate motor speed. In such embodiments, the controller 36 may control the electronic brake 50 to induce an alternative haptic and/or auditory vibration rather than control current to the motor 6. For example, the controller 36 may pulse the electronic brake 50 at a specified frequency to induce the desired vibration. Using the electronic brake 50 may be advantageous because controlling the electronic brake 50 as described may result in higher amplitude vibrations as compared to vibrations generated by controlling the motor directly.

Although the motor control systems 100, 102 that provide haptic feedback to a user of the tool are illustrated herein with respect to a hand-held rotary tool 1, the application of the motor control systems 100, 102 are not limited to this type of power tool. For example, the motor control systems 100, 102 can be implemented in different types of hand-held power tools including angle grinders, jig saws, oscillating saws, reciprocating saws, drills, etcetera. Moreover, the motor control systems 100, 102 can be implemented in cabinet and/or table mounted power tools.

Although the motor 6 is a DC motor that is controlled by voltage and current, the motor 6 is not limited to this type of motor. For example, in some embodiments, the motor 6 may be a brushless DC stepper motor that rotates in discrete steps controlled by digital pulses transmitted from the controller 36.

Although three specific informing foldback mechanisms 80, 80, 82 have been described herein, the tool 1 is not limited to these mechanisms. In some embodiments, different sensors may be employed to provide other informing foldback mechanisms. In some embodiments, a single informing feedback mechanism is provided. In other embodiments, two, three or more informing foldback mechanisms are provided.

Selective illustrative embodiments of a hand-held power tool including a motor control system that provides haptic and/or auditory feedback to a tool user are described above in some detail. Only structures considered necessary for clarifying the tool and system have been described herein. Other conventional structures, and those of ancillary and auxiliary components of the tool and system are assumed to be known and understood by those skilled in the art. Moreover, while working examples of the tool and system have been described above, the tool and/or system are not limited to the working examples described above, but various design alterations may be carried out without departing from the tool and system as set forth in the claims.

What is claimed is:

1. A hand-held power tool, comprising:
a tool housing;
an electric motor disposed in the tool housing, the electric motor having an output shaft that is configured to be connected to an accessory of the tool;
a power supply that provides power to the electric motor; and
a controller disposed in the tool housing and powered by the power supply, the controller configured to control a speed of the motor,
wherein
the power tool has characteristic vibrations that result in at least one of a characteristic haptic effect and a characteristic auditory effect that are perceivable by a user of the tool,
the controller is configured to control the motor in such a way that the power tool is capable of producing alternative vibrations that result in at least one of an alternative haptic effect and an alternative auditory effect,
the alternative haptic effect is different than the characteristic haptic effect, and
the alternative auditory effect is different than the characteristic auditory effect.

2. The power tool of claim 1, wherein
the controller is configured to receive a signal corresponding to a detected load on the electric motor during motor operation, and
when the controller determines that the detected load on the electric motor exceeds a predetermined load, the controller is configured to control the motor in such a way that the motor provides the alternative haptic effect indicating an overload state of the motor to a user of the power tool.

3. The power tool of claim 2, wherein the alternative haptic effect comprises changes in motor speed of the type selected from the following group: rhythmic, musical, discontinuous, non-linearly varying, sinusoidally varying.

4. The power tool of claim 2, wherein
the alternative haptic effect comprises cycling the motor speed in a repeated pattern in which the speed of the motor is reduced from a set speed to a predetermined speed and then increased from the predetermined speed to the set speed.

5. The power tool of claim 2, wherein
the alternative haptic effect comprises cycling the motor speed in a repeated pattern in which the speed of the motor is reduced from a set speed to a predetermined speed and then increased from the predetermined speed to the set speed in accordance with a predefined rhythm.

6. The power tool of claim 2, wherein the controller is configured to control the motor in such a way that the motor provides both the alternative haptic effect and the alternative auditory effect to the user.

7. The power tool of claim 1, wherein
the controller is configured to receive a signal corresponding to a detected charge condition of the power supply during motor operation, and
when the controller determines that the detected charge condition is less than a predetermined charge condition, the controller is configured to control the motor in such a way that the motor provides the alternative haptic effect indicating a low charge state of the power supply to a user of the power tool.

8. The power tool of claim 7, wherein the controller is configured to control the motor such that both the alternative haptic effect and the alternative audible effect are provided to the user.

9. The power tool of claim 1, wherein
the controller is configured to receive a signal corresponding to a detected angular orientation of the tool housing in space during tool operation, and
when the controller determines that the detected angular orientation of the tool housing is outside a predetermined range of acceptable angular orientations of the tool housing, the controller is configured to control the motor in such a way that the motor provides the alternative haptic effect indicating a suboptimal tool housing orientation to a user of the power tool.

10. The power tool of claim 9, wherein the controller is configured to control the motor such that both the alternative haptic effect and the alternative audible effect are provided to the user.

11. The power tool of claim 1, wherein
the controller is configured to detect a current provided to the electric motor during motor operation, and
when the detected current corresponds to a first current that results in vibrations known to be perceived negatively by a user, the controller is configured to control the motor in such a way that the motor provides the alternative haptic effect.

12. The power tool of claim 11, wherein when the detected current corresponds to a first current that results in vibrations known to be perceived negatively by a user, the controller is configured to control the motor in such a way that the motor provides vibrations known to be perceived positively by a user.
